(19) United States
(12) Patent Application Publication
(10) Pub. No.: US 2009/0313802 A1
(43) Pub. Date: Dec. 24, 2009

(54) METHOD AND APPARATUS FOR FITTING GRIPS

(76) Inventor: Mark Schell, Mordialloc (AU)

Correspondence Address: HESLIN ROTHENBERG FARLEY & MESITI PC, 5 COLUMBIA CIRCLE, ALBANY, NY, 12203, US

(21) Appl. No.: 11/917,139

(22) PCT Filed: May 23, 2006
(86) PCT No.: PCT/AU2006/000684

§ 371 Date: May 22, 2008

(30) Foreign Application Priority Data
Jun. 10, 2005 (AU) 2005902728

(51) Int. Cl. B23P 11/02; B23P 19/00

(52) U.S. Cl. 29/450; 29/235

(57) ABSTRACT

The present invention relates to a method and apparatus for fitting grips to hand-held equipment, such as sporting equipment, for example cricket bats, by sliding a grip over the hand-held equipment. The apparatus comprises means that carries a tubular grip over a handle. The carrying means is adapted to fit between the handle and the grip to reduce friction between the handle and grip and thereby enable the grip to slide over the handle. The method of the present invention involves positioning the carrying means inside a grip, sliding the carrying means over the handle to slide the grip over the handle and removing the carrying means from between the grip and the handle.

### FIELD OF THE INVENTION

The present invention relates to a method and apparatus for fitting grips to hand-held equipment to improve a user's control of the equipment. The invention has particular application to equipment having handles fitted with tubular grips. The present invention has particular, although not exclusive, application to sporting equipment, such as cricket bats.

### BACKGROUND OF THE INVENTION

One known form of grip, used commonly with cricket bats, is a tubular grip or sleeve of rubber that fits over a handle. The grip is retained in position on the handle by friction with the underlying material, typically string bound around the handle. Furthermore, the handle is dimensioned slightly larger than the dimensions of the grip such that the grip is in an expanded state when fitted to the bat handle so the resilient nature of the rubber grip prevents or minimises the grip shifting on the handle in use.

While the friction that exists between a rubberised grip and a handle assists to prevent movement of the grip, the friction causes difficulty in applying the tubular grip to the handle. Consequently, sliding a rubberised tubular grip onto the handle of a cricket bat, for instance, is extremely difficult and is likely to result in destruction of the rubber grip.

The typical method for applying a tubular rubber grip to a cricket bat handle overcomes this problem by rolling the grip back onto itself to form a toroid. The rolled up grip is then located on the top of the handle and forced over the top of the handle by unrolling the grip along the length of the handle.

This approach suffers from not being able to accurately control the resultant location of the grip relative to the handle. For instance, the rubber grip may cover too much or too little of the handle. Once rolled onto the handle, the position of the grip on the handle can only be adjusted to a limited extent and with difficulty owing to the friction between the grip and handle. While minor adjustments of the grip may be possible, a major adjustment requires removal of the grip from the handle and its reapplication in the manner described above.

This approach also suffers from the problem of forcing the rolled up grip over an enlarged end of the handle. The enlarged end prevents grips from sliding off the handle by forcing the grip to expand and resist further movement by virtue of the resilient nature of the rubber grip. Rolling the rolled-up grip over the enlarged end is made more difficult by the fact that the rolled-up grip is harder to force over the enlarged end.

### SUMMARY OF THE INVENTION

The present invention is concerned with alleviating, at least in part, the problems associated with applying friction-fitted grips to handles.

According to a first aspect of the invention, there is provided an apparatus for fitting tubular grips to handles, the apparatus comprising:

means for carrying a tubular grip over a handle and being adapted to fit between the tubular grip and the handle to reduce friction between the tubular grip and the handle and thereby enabling the tubular grip to slide onto the handle.

Enabling the grip to be slid onto the handle avoids the problems mentioned above associated with rolling the rolled-up grip onto the handle.

The apparatus may further comprise means for positioning the carrying means between the tubular grip and the handle.

The carrying means preferably comprises one or more elongate members configured to fit between the detachable grip and the handle. Preferably, the carrying means comprises eight narrow elongate members and, more preferably, the carrying means comprises six narrow elongate members.

The elongate members of the carrying means preferably have a profile that, when fitted between the tubular grip and the handle, reduces the area of contact between the tubular grip and the handle and thereby reduces friction between the tubular grip and the handle to such an extent that the grip is able to slide onto the handle.

In other words, the elongate members of the carrying means preferably have a profile to space a grip from the handle, at least, in a localised region of the elongate members when fitted between the tubular grip and the handle.

In one embodiment, the elongate members are tapered along their length.

The elongate members preferably are flexible to conform to the shape of the handle to accommodate a force supplied to the elongate members by an expanded tubular grip as it slides over the handle.

Suitable materials for forming the elongate members may include low friction material such as high density polyethylene, nylon, polyvinylchloride or nylon rope, such as marine rope.

The positioning means preferably has one or more guides for directing the carrying means into contact with the tubular grip for carrying the tubular grip over the handle.

Preferably, the positioning means has a plurality of guides and each guide assists to maintain the elongate members at substantially equidistant spacings about the positioning means.

By maintaining such spacings, the elongate members are prevented from bunching. If bunching occurs, the elongate members only reduce the friction between the handle and grip in a localised region. In other regions where the grip is in contact with the handle, the friction may prevent the grip being slid onto the handle. In essence, the correct spacing of elongate members ensures sufficient friction reduction to enable the grip to be slid onto the handle.

The or each guide may be formed so the profile of the carrying means is at least partly raised above the adjacent surface of the positioning means when the carrying means is located in association with the one or more guides.

The or each guide may comprise a groove formed in the positioning means for positioning one of the one or more elongate members into contact with the tubular grip in substantially longitudinal alignment with the handle and a tubular grip. Preferably, there is one groove formed in the positioning means for each elongate member.

The positioning means may have a profile that tapers outwardly to a handle-abutting end that has a dimension slightly larger than the dimension of the handle so that the elongate members extend from the positioning means over the handle end and into contact with the sides of the handle. The grooves may be formed in the tapered surface proximate to the handle-abutting end of the positioning means.

The guides preferably further include cavities in communication with each groove for directing the movement of an elongate member through the cavity into a groove formed on the positioning means.

The positioning means and elongate members preferably are co-operable for retaining the elongate members in a position ready to receive a grip for sliding the grip onto the handle. The co-operation of the positioning means and the elongate members enables the elongate members to be loaded sequentially into positioning means without the loaded elongate members moving from the ready position during loading of the remaining elongate members.

The elongate members preferably have projections that frictionally fit with slots on the positioning means to retain the elongate members in the ready position and to release the elongate members on application of a force for sliding the elongate members over a handle.

Each elongate member may have a lug such that when the elongate members are loaded on the positioning means the lugs of the elongate members collectively form a stop for limiting the extent to which a grip that is located over the positioning means extends over the elongate members.

According to a second aspect of the invention, there is provided a method for applying the tubular grip to the handle, the method including the steps of:
(a) positioning carrying means inside the tubular grip to extend over sides of the handle;
(b) sliding the grip onto the handle by sliding the carrying means over the sides of the handle to carry the grip over the handle; and
(c) removing the carrying means from between the grip and the handle.

The method preferably comprises locating the sliding means in association with a positioning means for positioning the carrying means inside the tubular grip and for guiding the carrying means between the grip and the sides of the handle prior to positioning the carrying means inside the tubular grip.

The step of removing the sliding means from between the grip and the handle may involve sequentially retracting each elongate member comprising the carrying means from between the grip and the handle.

### BRIEF DESCRIPTION OF THE DRAWINGS

A preferred embodiment of the invention will now be described, by way of example only, with reference to the accompanying drawings, in which:

FIG. 1 is a cutaway view of a tubular grip applied to a handle by an apparatus according to the first aspect of the present invention.

FIG. 2 is an isometric view of a delivery means of a grip fitting apparatus shown in FIG. 1.

FIG. 3 is a plan view of a carrying means of the grip fitting apparatus in FIG. 1.

FIG. 4 is an isometric view of the grip fitting apparatus in FIG. 1 in preparation for applying a grip to a handle.

FIG. 5 is a transverse cross-section of the grip fitting apparatus and grip along the line V-V in FIG. 1, but including 6 elongate members for clarity, rather than 8 elongate members.

FIG. 6 is a longitudinal cross-section of the handle, grip fitting apparatus and grip along the line VI-VI in FIG. 1.

FIG. 7 is an isometric view of another form of apparatus according to the first aspect of the present invention.

FIG. 8 is an isometric view of carrying means of the apparatus in FIG. 7.

FIG. 9 is a plan view of the handle-abutting end of the body of the apparatus in FIG. 7.

### DETAILED DESCRIPTION OF AN EMBODIMENT

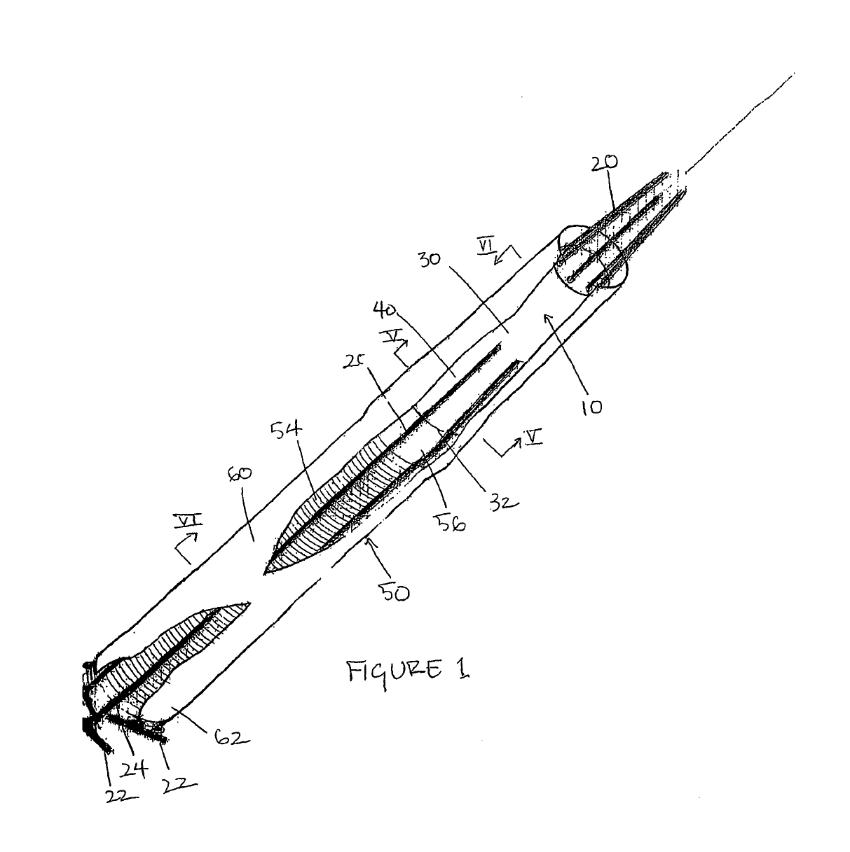

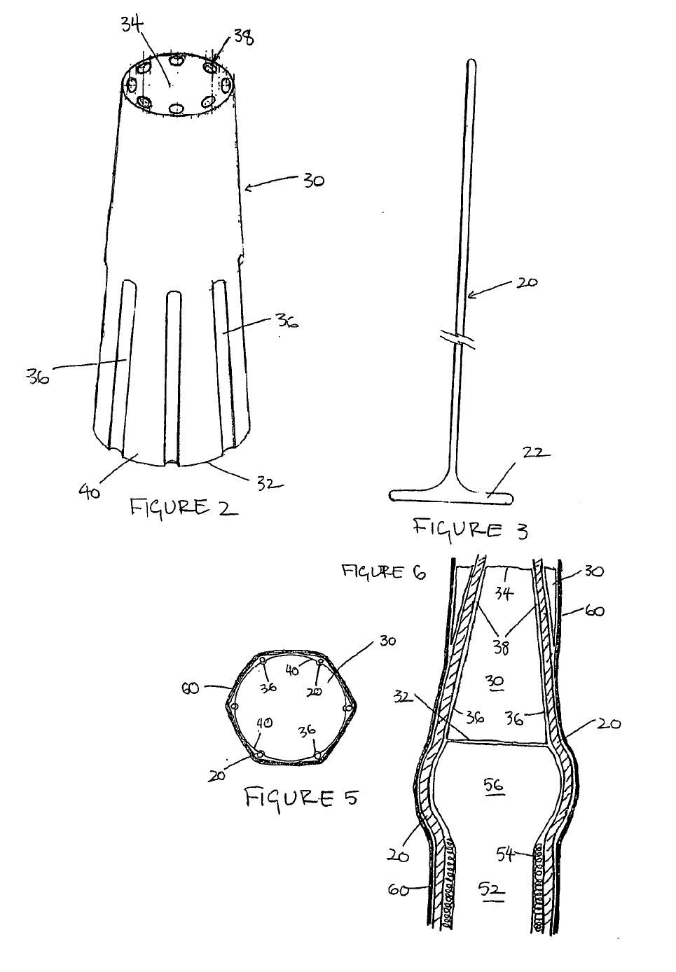

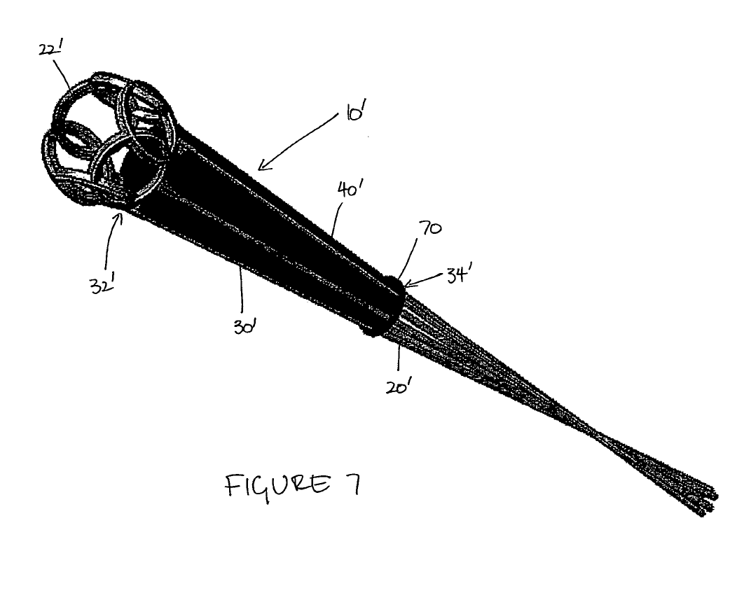

One embodiment of a grip fitting assembly 10 in accordance with the first aspect of the present invention is shown in FIGS. 1-6.

The assembly 10 comprises carrying means in the form of runners 20 and a positioning means in the form of body 30.

The runners 20 have a thin flexible body approximately 35 cm long and 2 mm wide. Each runner 20 has a handle 22 formed as a perpendicular extension from one end of each runner 20. Each handle 22 is formed to enable a user to pull on the handles collectively to pull a grip 60 onto a handle 50 and to enable a user to retract a runner 20 from between the grip 60 and the handle 50 once the grip 60 is located on the handle 50.

The body 30 has a generally frusto-conical form with a delivery end 32 and a free end 34.

Grooves 36 are formed in surface 40 of the body 30 and are linked to cavities or channels 38 that extend from the grooves 36 through the body 30 and open at the free end 34. The grooves 36 and channels 38 are arranged in the body 30 to guide the runners 20 in between the grip 60 and handle 50 with substantially equidistant spacing between adjacent runners 20 to prevent bunching of the runners and to ensure friction is reduced to enable the grip 60 to be slid onto the handle 50.

Another embodiment of a grip fitting assembly 10′ is shown in FIGS. 7 to 9. Features in this embodiment similar to the features of the embodiment shown in FIGS. 1 to 6 are denoted with the same reference numerals and a prime (′).

Referring to FIGS. 7 and 9, the body 30′ has a flange 70 at the free end 34′ and grooves (not shown) that extend along the body 301 from the delivery end 32′ to the flange 70. The flange 72 has a series of holes (not shown) spaced around the flange 70 such that each hole opens onto a respective groove. Accordingly, a runner 20′, when loaded onto the body 30′, extends along the groove and through the hole in the flange 70.

Referring to both embodiments, the grooves 36 and channels 38 have a profile that complements the runners 20 and 20′. Furthermore, the grooves 36 have a shallow profile so that, when a runner 20, 20′ is seated in a groove 36, at least part of the runner 20 is raised above the adjacent surface 40, 40′ of the body 30, 30′, as shown in FIGS. 5 and 7.

Each runner 20′ has a handle 22′ in the form of a ring to improve the ease of grasping the runner 20′ to apply a force for sliding the runner 20′ over a handle 50 and to remove the runner 20′ from between the handle 50 and grip 60 once the grip 60 is applied to the handle 50.

The delivery end 32, 32′ has a size that is slightly greater than the diameter of an enlarged end 56 of handle 50. The sizing of the delivery end 32, 32′ guides the delivery of the runners 20, 20′ over the enlarged end 56 when the runners 20, 20′ are shrouded in a grip 60.

The assembly may include one or more runners 20 suitably shaped to fit between the handle 50 and grip 60 to reduce friction between the handle 50 and grip 60 and thereby enable the grip 60 to slide over shaft 52 of the handle 50. The embodiment in FIG. 1 to 6 is shown with two variations, namely with six runners 20 and with eight runners 20 to show that the functional difference between having six and eight runners is immaterial. Nevertheless, the assembly 10 may be modified to operate with as little as one runner 20 formed as a flexible sheet (not shown) that lines the grip 60.

The body 30, 30′ may be formed of high density polyethylene, polyvinylchloride or nylon or similar low friction material. The runners 20, 20′ may be made of similar materials and advantageously have a relatively low co-efficient of friction relative to rubber grips 60, such as grips for cricket bats. Alternatively, the runners 20, 20′ may be formed of thin marine rope having a diameter no greater than 2 mm.

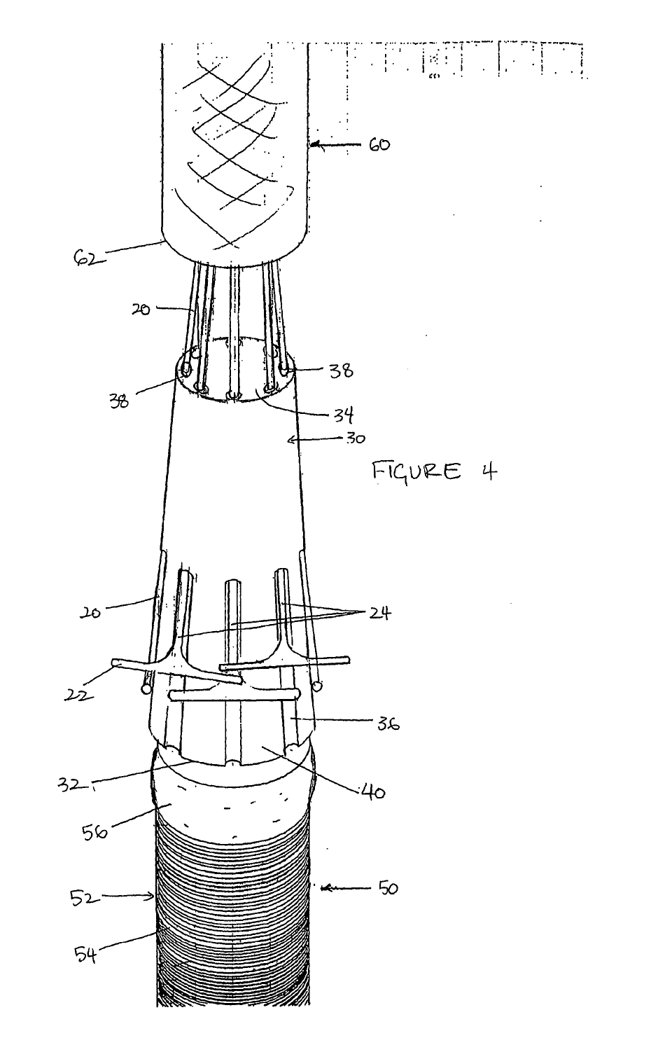

In order to apply a grip 60 to a handle 50, the runners 20, 20′ are loaded into grooves 36 such that a major portion of the runners 20, 20′ extend through the channels 38 (FIG. 4) or holes in the flange 70 (FIGS. 7 and 9) and from the free end 34 of the body 30.

With particular reference to FIGS. 1, 4 and 6, the free ends of the runners 20 are inserted inside the tubular grip 60. The grip 60, is an unrolled state, that is, in the form of an elongate tube, is brought down over the body 30 such that a forward end 62 of the grip 60 contacts leading portions 24 of the runners 20 that are set in the grooves 36. The forward end 62 contacts the leading portions 24 at a point on the body 30 where the inner circumference of the grip 60 is the same as the virtual circumference defined by a line interconnecting the leading portions 24. Forcing the grip 60 further towards the delivery end 32 of body 30 expands the circumference of forward end 62 and brings the grip 60 firmly into contact with the leading portions 24. The grip 60 then remains stationary relative to the runners 20 such that further movement of the grip 60 over the body 30 results in the runners 20 moving relative to the body 30 to advance the grip 60.

As the grip 60 advances further over body 30, the handles 22 of the runners 20 extend over an enlarged end 56 of the handle 50 and carry the forward end 62 of the grip 60 also over the enlarged end 56.

Further movement of the grip 60 causes a further portion of each runner to come into contact with a further portion of the grip as the leading portions 24 of the runners 20 extend down the sides of the shaft 52 over wound string 54.

The grip 60 may be advanced over the handle 50 by pushing the grip 60 or by pulling collectively on the runners 20 so the grip 60 slides onto the handle 50.

The profile of the runners 20 raises the grip 60 above the wound string 54 at least adjacently to the runners 20 to reduce the overall friction between the grip 60 and handle 50. Consequently, the runners 20 slide over the string 54 and carry the grip 60 over the shaft 52 until the grip 60 reaches a desired location of a user. Upon reaching the desired location, a user retracts the runners 20 by grasping a handle 22 and pulling a runner 20 out from between the grip 60 and handle 50. Each runner is removed in succession to avoid shifting grip 60 along the shaft 52 from the desired position.

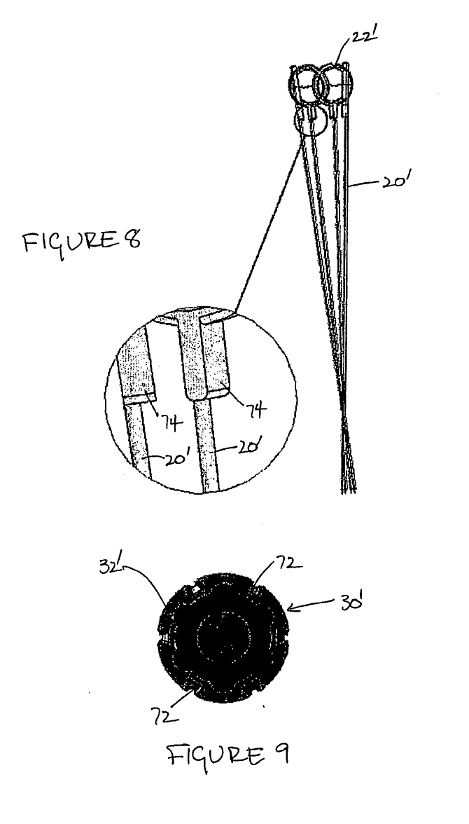

The body 30′ (FIGS. 7 and 9) includes slots 72 and the runners 20′ (FIGS. 7 and 8) have projections, in the form of plugs 74. The slots 72 and plugs 74 are formed such that they frictionally engage to retain the runners 20′ in a position ready to receive a grip 60 (FIG. 7) for sliding the grip 60 onto the handle 22. The co-operation of the slots 72 and plugs 70 enables the runners 20′ to be loaded sequentially into the body 30′ without the loaded runners 20′ moving from the ready position during loading of the remaining runners 20′.

The frictionally engagement between the slots 72 and plugs 74 enables the runners 20′ to be released from the body 30′ on application of a force for sliding the runners 20′, and a grip 60 carried on the runners 201, over a handle 50.

Each runner 20′ may also have a lug (not shown) such that, when the runners 20′ are loaded onto the body 30′, the lugs collectively form a stop for limiting the extent to which the grip 60, that is located over the body 30, extends over the runners 20′ prior to sliding the grip 60 over the handle 22.

The above described method and apparatus for fitting grips to handles can be used to fit additional grips over an existing grip on a handle.

Many modifications may be made to the preferred embodiment of the present invention as described above without departing from the spirit and scope of the present invention.

For example, it is envisaged that the invention may be incorporated in a machine that applies grips to handles by utilising the method and/or apparatus described above or an alternative embodiment thereof.

1. An apparatus for fitting tubular grips to handles the apparatus comprising:
means for carrying a tubular grip over a handle and being adapted to fit between the tubular grip and the handle to reduce friction between the tubular grip and the handle and thereby enabling the tubular grip to slide onto the handle.

2. The apparatus defined in claim 1, wherein the apparatus further comprises means for positioning the carrying means between the tubular grip and the handle.

3. The apparatus defined in claim 2, wherein the positioning means has one or more guides for directing the carrying means into contact with the tubular grip for carrying the tubular grip over the handle.

4. The apparatus defined in claim 1, wherein the carrying means comprises one or more elongate members configured to fit between the grip and the handle.

5. The apparatus defined in claim 4, wherein the carrying means comprises eight narrow elongate members.

6. The apparatus defined in claim 4, wherein the carrying means comprises six narrow elongate members.

7. The apparatus defined in claim 4, wherein the elongate members have a profile that, when fitted between the tubular grip and the handle, reduces the area of contact between the tubular grip and the handle and thereby reduces friction between the tubular grip and the handle to such an extent that the grip is able to slide onto the handle.

8. The apparatus defined in claim 4, wherein the elongate members have a profile to space a grip from the handle, at least, in a localised region of the elongate members when fitted between the tubular grip and the handle.

9. The apparatus defined in claim 4, wherein the elongate members are tapered along their length.

10. The apparatus defined in claim 4, wherein the elongate members are flexible to conform to the shape of the handle to accommodate a force supplied to the elongate members by an expanded tubular grip as it slides over the handle.

11. The apparatus defined in claim 4, wherein the elongate members are formed of low friction material.

12. The apparatus defined in claim 4, wherein the elongate members are formed of density polyethylene, nylon, polyvinylchloride or nylon rope.

13. The apparatus defined in claim 3, wherein the or each guide is formed so the profile of the carrying means is at least partly raised above the adjacent surface of the positioning means when the carrying means is located in association with the one or more guides.

14. The apparatus defined in claim 13, wherein the or each guide comprises a groove formed in the positioning means for positioning one of the one or more elongate members into contact with the tubular grip in substantially longitudinal alignment with the handle and a tubular grip.

15. The apparatus defined in claim 14, wherein the carrying means comprises one or more elongate members and the positioning means has one groove for each elongate member.

16. The apparatus defined in claim 15, wherein the positioning means has a profile that tapers outwardly to a handle-abutting end that has a dimension slightly larger than the dimension of the handle so that the elongate members extend from the positioning means over the handle end and into contact with the sides of the handle.

17. The apparatus defined in claim 16, wherein the grooves are formed in the tapered surface proximate to the handle-abutting end of the positioning means.

18. The apparatus defined in claim 17, wherein the guides further include cavities in communication with each groove for directing the movement of an elongate member through the cavity into a groove formed on the positioning means.

19. The apparatus defined in claim 15, wherein the positioning means and elongate members are co-operable for retaining the elongate members in a position ready to receive a grip for sliding the grip onto the handle.

20. The apparatus defined in claim 19, wherein the elongate members have projections that frictionally fit with slots on the positioning means to retain the elongate members in the ready position and to release the elongate members on application of a force for sliding the elongate members over a handle.

21. The apparatus defined in claim 15, wherein the positioning means has a plurality of guides for maintaining the elongate members at substantially equidistant spacings about the positioning means.

22. The apparatus defined in claim 15, wherein each elongate member has a lug such that when the elongate members are loaded on the positioning means the lugs of the elongate members collectively form a stop for limiting the extent to which a grip that is located over the positioning means extends over the elongate members.

23. A method for applying a tubular grip to a handle, the method including the steps of:
(a) positioning carrying means inside the tubular grip to extend over sides of the handle;
(b) sliding the grip onto the handle by sliding the carrying means over the sides of the handle to carry the grip over the handle; and
(c) removing the carrying means from between the grip and the handle.

24. The method defined in claim 23, wherein step (a) comprises locating the sliding means in association with a positioning means for positioning the carrying means inside the tubular grip and for guiding the carrying means between the grip and the sides of the handle prior to positioning the carrying means inside the tubular grip.

25. The method defined in claim 23, wherein step (c) comprises sequentially retracting each elongate member comprising the carrying means from between the grip and the handle.

26. An apparatus for fitting tubular grips to handles the apparatus comprising:
means for carrying a tubular grip over a handle and being adapted to fit between the tubular grip and the handle to reduce friction between the tubular grip and the handle and thereby enabling the tubular grip to slide onto the handle; and
said means including portions for gripping by a user to retract said means from between the tubular grip and the handle when the tubular grip is located on the handle.
